(19) United States
(12) Patent Application Publication
(10) Pub. No.: US 2004/0171447 A1
(43) Pub. Date: Sep. 2, 2004

(54) Ratchet type tensioner

(76) Inventors: Isamu Okabe, Osaka (JP); Yoshio Kurokawa, Osaka (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/738,395

(22) Filed: Dec. 17, 2003

(30) Foreign Application Priority Data
Feb. 28, 2003 (JP) 2003-054729

(51) Int. Cl. F16H 7/08; F16H 7/22

(52) U.S. Cl. 474/109; 474/110

(57) ABSTRACT

In ratchet type tensioner, low cost, high strength and excellent wear resistance, are realized by utilization of a pawl composed of a sintered alloy having a density of 6.8 g/cm³ or more, and containing 5-15 wt % Co, a total of 2.0-10 wt % of at least one metal from Ni, Cr and Mo, and the balance Fe and impurities.

### FIELD OF THE INVENTION

This invention relates to a tensioner for a chain transmission device of the kind used in an automobile or motorcycle. More specifically it relates to a ratchet type tensioner, which uses a ratchet mechanism to limit the retracting movement of a plunger.

### BACKGROUND OF THE INVENTION

In the engine of an automobile, a motorcycle or the like, a transmission medium using a metal chain, such as a roller chain, a silent chain, or the like, is used in the timing transmission to drive the valve operating camshaft from the engine crankshaft. A tensioner is used to take up slack due to elongation of the chain, and to maintain constant tension in the transmission medium.

Among the various types of tensioners, one which is used widely in a variety of applications is the ratchet type tensioner. In the ratchet-type tensioner, a plunger slidable in a housing and biased in a projecting direction, is prevented from retracting by a ratchet mechanism in which a pawl on the housing engages a rack formed on a side of the plunger.

In a ratchet type tensioner, the plunger is continually subjected to impact and vibration. Accordingly the plunger is required to have high wear resistance and high durability. The plunger of a ratchet type tensioner is typically composed of carbon steel, for example, S35C to S45C, according to JIS G4051, and the plunger is subjected heat treatment by quenching and tempering. On the other hand, the pawl, which prevents retracting movement of the plunger, is not directly subjected to impact and vibration. Accordingly, the material and strength of the pawl have not been considered important, and pawls for ratchet type tensioners have typically been composed of a sintered alloy having a density of 6.9 to 7.1 g/cm³, which is advantageous because of its low cost.

Recently, due to the trend toward higher engine power, the force applied to the plunger is increased, and a large load is applied to the ratchet mechanism, causing the pawl to become worn and damaged. Eventually the ratchet mechanism fails, and is no longer able to prevent return movement of the plunger.

In a direct injection type gasoline engine or a diesel engine, in which fuel is directly injected into the cylinders, carbon soot is generated due to a partial burning phenomenon in which the diffusion of fuel does not progress, and flame transmission discontinues. The carbon soot, which is essentially cinders, enters gaps between the pawl and the rack of the plunger, forming inclusions which cause abrasive wear of the pawl.

Furthermore, when an engine is used over a long period of time without an oil change, impurities such as wear powder and carbon soot enter the deteriorated oil, accelerating the wear of the pawl. In the worst case, breakage of the pawl can lead to engine failure.

For these reasons, in order to improve the durability of the pawl, it has been proposed to form the pawl from a hard alloy steel such as a chromium steel, for example, SCr 420 according to JIS 4104, chromium molybdenum steel, or the like. However, the production cost of a pawl made from a hard alloy steel is higher than in the case where a sintered alloy is used. Due to the recent consumer demand for lower prices in motor vehicles and their parts, the trade-off between high strength and high wear resistance on the one hand, and low cost on the other hand, has become a problem requiring urgent attention.

Accordingly, among the objects of the invention are the solution of the above-mentioned problems of the conventional ratchet type tensioner, and the provision of a low cost ratchet type tensioner having a high strength and superior wear resistance.

### SUMMARY OF THE INVENTION

The ratchet type tensioner in accordance with the invention comprises a housing, a plunger slidable in, and protruding from, the housing, and biased in a protruding direction, a ratchet mechanism comprising a rack formed on a side surface of the plunger, and a pawl provided on the housing and engageable with the rack to prevent retracting movement of the plunger, wherein the pawl is composed of a sintered alloy having a density of at least 6.8 g/cm³ and containing 5 to 15 wt % Cobalt (Co), a total of 2.0 to 10 wt % of at least one metal from the group consisting of Nickel (Ni), Chromium (Cr) and Molybdenum (Mo), and the balance Iron (Fe) and impurities.

The Cobalt in the sintered alloy acts as a hard phase, and, although the sintering density of the alloy is lower than that of the sintered alloy in the pawl of a conventional ratchet type tensioner, the pawl of the invention exhibits remarkably improved wear resistance. Furthermore, Nickel, Chromium, and Molybdenum act synergistically with the hard phase formed by the Cobalt, and thereby improve the hardness, strength, and tempering softening resistance of the pawl.

When the Cobalt content in the sintered alloy is less than 5 wt %, the action of the hard phase in improving wear resistance is insufficient. On the other hand, when the Cobalt content exceeds 1.5 wt %, not only is the cost increased, but the pawl has increased porosity, the porous structure being characterized by small cavities between metal particles. The porosity undesirably blocks the formation of the hard phase. Therefore, it is preferred that the Cobalt content be in the range from 5 to 15 wt %.

Furthermore when the total amount of Ni, Cr, or Mo in the sintered alloy is less than 2.0 wt %, the strength of the iron matrix becomes insufficient, and the effect of the Cobalt hard phase is insufficient. On the other hand, when the total amount of Ni, Cr, or Mo exceeds 10 wt %, the effects of these components becomes saturated, the cost is increased, and a porous structure characterized by cavities undesirably blocks the formation of the Co hard phase. Therefore, it is preferred that the total content of Ni, Cr and Mo be within the range from 2.0 to 10 wt %.

The reason for the lower limit of 6.8 g/cm³ on the density of the sintered alloy is that, when the density is less than 6.8 g/cm³, cavities in the sintered alloy become excessive, and wear resistance is reduced irrespective of the presence or absence of the added Co, Ni, Cr, Mo components. There is no particular upper limit on the density of the sintered alloy, but the Co, Ni, Cr, Mo should be present within a range, that will not result in excessive cost. At a density from 6.8 to 6.95 g/cm³, a remarkable improvement in wear resistance is realized.

### BRIEF DESCRIPTION OF THE DRAWINGS

FIG. 1(a) is an elevational view of a timing chain system using a ratchet type tensioner of the invention;

FIG. 1(b) is an enlarged view of a pawl;

FIG. 2 is a graph showing the relationship between Co content and sintering densities in the pawl;

FIG. 3 is a graph showing the relationship between Co content and wear ratio in the pawl;

FIG. 4 is a graph showing the relationship between Ni, Cr and Mo content and sintering densities in the pawl; and

FIG. 5 is a graph showing the relationships between Ni, Cr and Mo content and wear ratio in the pawl.

### DETAILED DESCRIPTION OF THE PREFERRED EMBODIMENTS

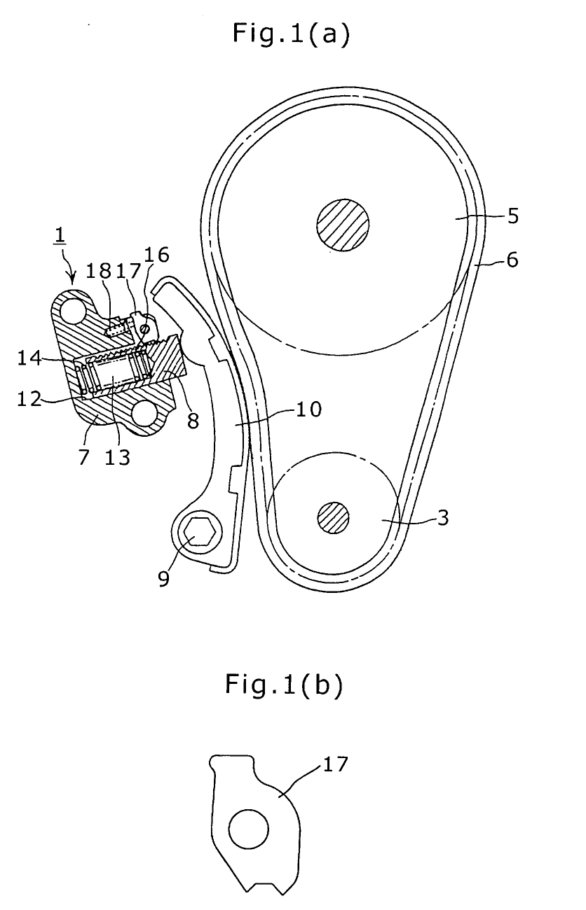

In the timing chain transmission shown in FIG. 1(a), a plunger 8 is slidable in a plunger-receiving hole 12 in the housing 7 of a tensioner 1. A spring 14, in compression between the bottom surface of the 12 and the plunger 8, fits into a hollow portion 13 in the plunger, biasing the plunger in a projecting direction, i.e., the direction in which it projects from the housing 7. The plunger 8 imparts tension, through a lever 10 pivoted on a pivot shaft 9, to an endless timing chain 6, which transmits rotation from a driving sprocket 3 to a driven sprocket 5.

To block retracting movement of the plunger 8, a pawl 17 pivoted on the housing 7, is biased by a ratchet spring 18 into engagement with a rack 16 formed on a side of the plunger.

Pawls according to the invention were produced by the following methods. To clarify the relationships between Cobalt content and wear resistance, a lubricant and graphite powder were mixed into six kinds of iron-base powders, and after molding the mixtures into the shape of a pawl at a molding pressure of 6 t/cm³, the pawls were sintered at 1200EC in a nitrogen gas atmosphere. After the sintering the pawls were subjected to carburization, quenching, and tempering. The six pawls, a conventional pawl, and five pawls according to the invention, designated A-E, had the following compositions:

Conventional type: 3 wt % Ni, 2 wt % Cr, the balance Fe and indispensable impurities;

A: 3 wt % Co, 1 wt % Ni, 1 wt % Cr, 4 wt % Mo, the balance Fe and indispensable impurities;

B: 5 wt % Co, 1 wt % Ni, 1 wt % Cr, 4 wt % Mo, the balance Fe and indispensable impurities;

C: 10 wt % Co, 1 wt % Ni, 1 wt % Cr, 4 wt % Mo, the balance Fe and indispensable impurities;

D: 15 wt % Co, 1 wt % Ni, 1 wt % Cr, 4 wt % Mo, the balance Fe and indispensable impurities;

E: 20 wt % Co, 1 wt % Ni, 1 wt % Cr, 4 wt % Mo, the balance Fe and indispensable impurities;

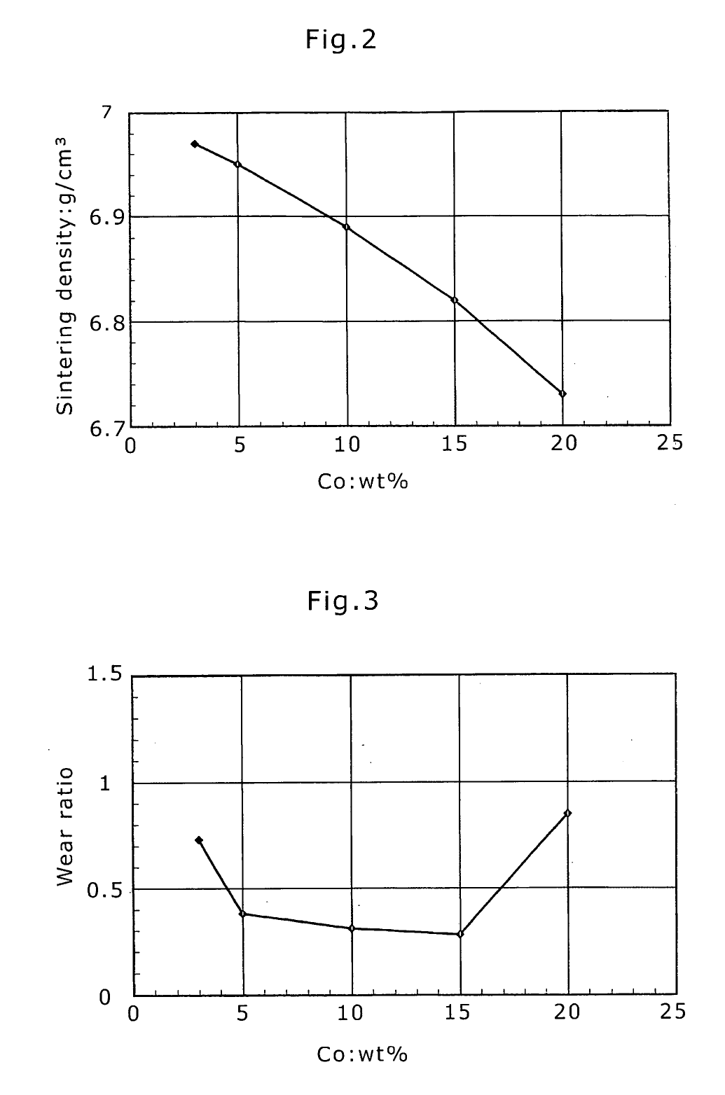

The relationship between additional amounts of Cobalt and sintering densities of the pawls is shown in FIG. 2. The results of wear tests with a motorized testing machine are shown in FIG. 3. The wear ratios depicted in FIG. 3 represent the wear losses of the respective examples A-E, compared to the wear loss, defined as 1, in the conventional product.

As apparent from FIG. 3, by setting the additional amount of Cobalt to a level within the range from 5 to 15 wt %, the amount of wear was reduced to about ⅓ of the wear in the conventional product. As shown in FIG. 2, with the Cobalt in the range from 5 to 15 wt %, sintering densities of at least 6.8 g/cm³ were ensured.

To clarify the relationship between additional amounts of Ni, Cr and Mo and wear resistance, additional pawls F-J were produced by the same methods as described above, using five kinds of iron-based powders, with the additional Cobalt held constant at a level of 10 wt %.

F: 10 wt % Co, 0.5 wt % Ni, 0.5 wt % Mo, the balance Fe and indispensable impurities;

G: 10 wt % Co, 1 wt % Ni, 1 wt % Mo, the balance Fe and indispensable impurities;

H: 10 wt % Co, 1 wt % Ni, 1 wt % Cr, 4 wt % Mo, the balance Fe and indispensable impurities (the same as that of the above-mentioned C);

I: 10 wt % Co, 2 wt % Ni, 2 wt % Cr, 6 wt % Mo, the balance Fe and indispensable impurities;

J: 10 wt % Co, 2 wt % Ni, 2 wt % Cr, 8 wt % Mo, the balance Fe and indispensable impurities;

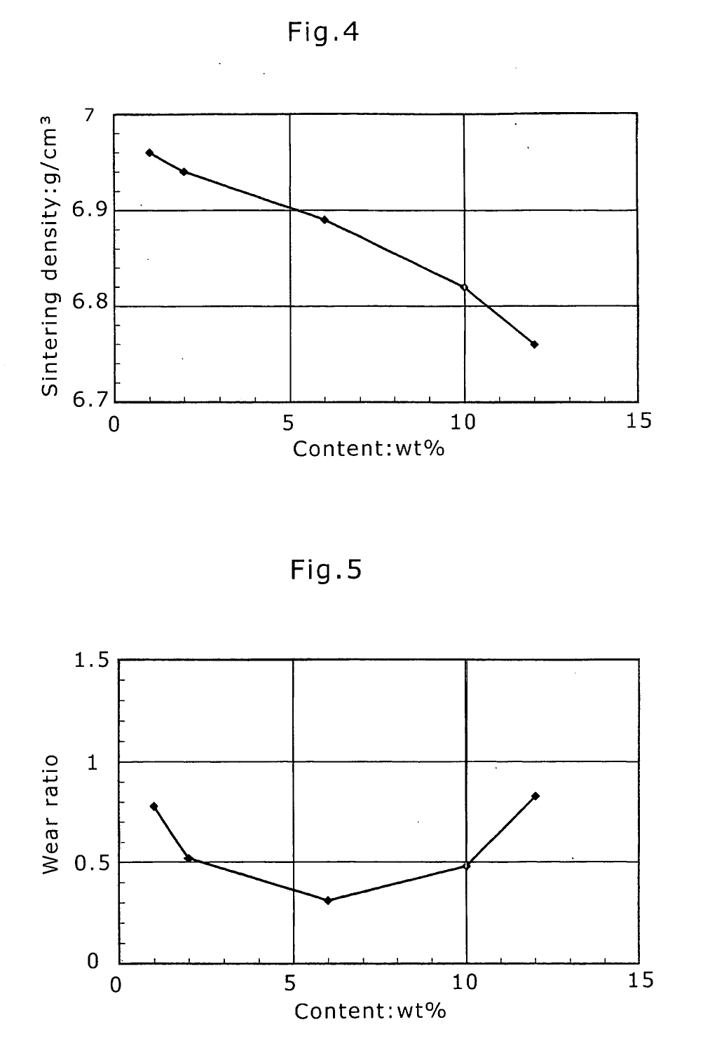

The relationships between additional amounts of Ni, Cr and Mo and sintering densities of the thus produced pawls are shown in FIG. 4. The abscissa represents the total content of Ni, Cr and Mo. The results of wear tests using a motorized testing machine are shown in FIG. 5. Here, as in FIG. 3, the wear ratios represent the wear losses of the respective examples F-J, compared to the wear loss, defined as 1, in the conventional product

As apparent from FIG. 5, when the total of the additional amounts of Ni, Cr, and Mo is less than 2 wt %, or more than 10 wt %, the improvement in wear resistance is markedly decreased. On the other hand, when the total of the additional amounts of Ni, Cr, and Mo is within the range from 2 to 10 wt %, wear losses are reduced to about ½ of the wear loss realized with the conventional product. Here again, as shown in FIG. 4, sintering densities of at least 6.8 g/cm³ were ensured.

The tensioner of the invention, can be used in a wide variety of applications, including transmission mechanisms, carrier systems, elevators and the like. However, it is particularly advantageous when used in the timing chain system of an engine, where the tensioner is subjected to severe high temperatures and an oxidizing environment.

In summary, according to the invention, the pawl of a ratchet mechanism is composed of a sintered alloy having a density of at least 6.8 g/cm³, and containing from 5 to 15 wt % Co, a total of 2.0 to 10 wt % of at least one metal from the group consisting of Ni, Cr, and Mo, and the balance Fe and impurities. The pawl having this composition exhibits significantly improved strength and wear resistance, and even if the tensioner is used in an adverse environment, such as in a diesel engine or a direct injection gasoline engine, where significant amounts of dirt and inclusions are generated, or in an engine in which the lubricating oil is in a deteriorated condition, wear of the pawl is reliably suppressed over a long period of time.

Furthermore, by controlling their compositions and sintering densities, sintered alloys having not only superior strength and wear resistance, but also superior toughness and corrosion resistance, can be produced consistently. The pawls can be produced by conventional equipment, and consequently no special capital investment is needed. Therefore, the tensioner according to the the invention is significantly advantageous from the standpoint of production cost, especially when compared with a conventional ratchet type tensioner using alloy steel, and requiring forging and machining steps.

We claim:

1. A ratchet type tensioner comprising a housing, a plunger slidable in, and protruding from, the housing, and biased in a protruding direction, a ratchet mechanism comprising a rack formed on a side surface of the plunger, and a pawl provided on the housing and engageable with the rack to prevent retracting movement of the plunger, wherein the pawl is composed of a sintered alloy having a density of at least 6.8 g/cm³ and containing 5 to 15 wt % Co, a total of 2.0 to 10 wt % of at least one metal from the group consisting of Ni, Cr and Mo, and the balance Fe and impurities.
